(19) United States
(12) Patent Application Publication
(10) Pub. No.: US 2025/0266725 A1
(43) Pub. Date: Aug. 21, 2025

(54) INDUCTION ELECTRIC MACHINE ROTOR AXIAL EFLUID CORE COOLING CHANNELS

(71) Applicant: FORD GLOBAL TECHNOLOGIES, LLC, Dearborn, MI (US)

(72) Inventors: Nicholas B. CHASE, Royal Oak, MI (US); Matthew SCHMITT, Salt Lake City, UT (US); Singar RATHNAM, Farmington Hills, MI (US); Joel HETRICK, Ann Arbor, MI (US)

(21) Appl. No.: 18/444,325

(22) Filed: Feb. 16, 2024

(51) Int. Cl. H02K 1/32

(52) U.S. Cl. CPC H02K 1/32

(57) ABSTRACT

An electric machine includes a shaft defining an axial fluid passage and a radial orifice extending from the fluid passage to an outer circumferential surface of the shaft. The machine further includes a rotor supported on the shaft. The rotor includes a stack of laminations defining a rotor core, an axial fluid channel defined in the rotor core and in fluid communication with the orifice and fluid passage, and a plurality of fins each extending from the rotor core into the fluid passage such that the fins axially extend along at least a portion of the axial fluid channel.

### TECHNICAL FIELD

The present disclosure relates to electric machines and thermal management thereof.

### BACKGROUND

Vehicles such as battery-electric vehicles and hybrid-electric vehicles include a traction-battery assembly that provides an energy source. The traction-battery assembly, for example, is electrically connected to an electric machine that provides torque to driven wheels. The traction-battery assembly may include components and systems to assist in managing vehicle performance and operations. It may also include high-voltage components, and an air or liquid thermal-management system to control temperature.

Electric machines typically include a stator and a rotor that cooperate to convert electrical energy into mechanical motion or vice versa. Electric machines may include thermal-management systems to cool the stator, rotor, or both.

### SUMMARY

According to one embodiment, an electric machine includes a shaft defining an axial fluid passage and a radial orifice extending from the fluid passage to an outer circumferential surface of the shaft. The machine further includes a rotor supported on the shaft. The rotor includes a stack of laminations defining a rotor core, an axial fluid channel defined in the rotor core and in fluid communication with the orifice and fluid passage, and a plurality of fins each extending from the rotor core into the fluid passage such that the fins axially extend along at least a portion of the axial fluid channel.

According to another embodiment, a rotor of an electric machine includes a rotor core having a central set of laminations disposed between first and second outer sets of laminations, wherein each of the first and second outer sets of laminations defines an axial fluid channel that has an outboard surface and an inboard surface, and the central set of laminations defines a fluid plenum having an outboard surface that is radially spaced from a central axis of the rotor core by a distance that is greater than a distance between the central axis and the outboard surfaces of the axial fluid channels of the first and second outer sets of laminations.

According to yet another embodiment, an electric machine includes a rotor core having a central portion with an outer circumferential surface and an inner circumferential surface, the inner surface defining a fluid plenum recessed therein and extending completely through an axial thickness of the central portion, wherein the fluid plenum has an outboard surface spaced from a central axis of the rotor core by a first distance. The rotor further has a first end portion axially thicker than the central portion and disposed against a first end face of the central portion, the first end portion having an outer circumferential surface, an inner circumferential surface, and a first axial fluid channel disposed therebetween, the first axial fluid channel having an outboard surface spaced from the central axis of the rotor core by a second distance that is less than the first distance. The rotor also has a second end portion axially thicker than the central portion and disposed against a second end face of the central portion such that the central portion is disposed between the first and second end portions, the second end portion having an outer circumferential surface, an inner circumferential surface, and a second axial fluid channel disposed therebetween, the second axial fluid channel having an outboard surface spaced from the central axis of the rotor core by a third distance that is less than the first distance. The plenum is circumferentially aligned with the first and second fluid channels forming a continuous opening extending axially through the rotor core.

In one or more embodiments, an induction rotor may be cooled by fluid (e.g., oil, ATF, or dielectric fluids) that is fed to a center of a rotor shaft axially from one end. Through centrifugal pumping by the shaft, the fluid may be distributed to passages in the rotor core through radial orifices in the center of the rotor shaft. A center portion of the rotor core laminations may include an open inner diameter at the shaft orifices to allow the fluid to enter the rotor core fluid circuit. The rotor core cooling channels are at a larger radial distance than the shaft to allow fluid to contact the core radially closer to the squirrel cage (also known as a “rotor cage”) of the rotor. This reduces thermal resistance between the conductor bars of the squirrel cage the fluid contacting the rotor core. The fluid is distributed axially through the rotor core via channels. Fluid exits the rotor-core channels and flows onto the end rings providing additional cooling to the squirrel cage.

To further aid cooling, fins may be added to the channels. For example, the fins may be tabs formed on the laminations creating small axial channels that act as a heat sink to the fluid. To distribute fluid more evenly to all the axial channels, an undercut may be included in the center laminations to create a plenum located centrally on the rotor core. The plenum reduces flow resistance and pressure drop and provides a circumferential path to each of the channels creating more even flow distribution. Additionally, the undercut on the sides of the plenum acts as an impeller or centrifugal pump at lower speeds increasing the fluid pressure so that it fills the plenum before entering the axial cooling channels. The fins may also aid cooling of the end rings by more evenly distributing fluid circumferentially in the rotor-core channels and providing smaller outlet passages, acting like nozzles, that more evenly spray exiting fluid onto the rotor cage end ring. Additionally, staggered fin channels may be used. The staggered fins may be formed by having two different fin channel laminations alternating in the axial direction of the rotor core.

### BRIEF DESCRIPTION OF THE DRAWINGS

FIG. 1 is side view, in cross section, of an example electric machine.

FIG. 2 is a perspective view of a rotor of the electric machine of FIG. 1.

FIG. 3 is a cross-sectional view of the rotor of FIG. 2 along cutline 3-3.

FIG. 4 is a cross-sectional view of the rotor of FIG. 2 along cutline 4-4.

FIG. 5 is a side cross-sectional view of another rotor.

FIG. 6 is a detail view of the another rotor illustrating one of the axial cooling channels and fin arrangement.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Directional terms used herein are made with reference to the views and orientations shown in the exemplary figures. A central axis is shown in the figures and described below. Terms such as “outer” (or “outboard”) and “inner” (or “inboard”) are relative to the central axis. For example, an “outer” surface means that the surfaces faces away from the central axis, or is outboard of another “inner” surface. Terms such as “radial,” “diameter,” “circumference,” etc. also are relative to the central axis. The terms “front,” “rear,” “upper” and “lower” designate directions in the drawings to which reference is made. The terms, connected, attached, etc., refer to directly or indirectly connected, attached, etc., unless otherwise indicated explicitly or by context.

A vehicle may include one or more electric machines that propel the vehicle. Such vehicles include electric vehicles and hybrid-electric vehicles. The vehicle includes an energy storage device, such as a traction battery for storing electrical energy. The battery is a high-voltage battery that is capable of outputting electrical power to operate the electric machine(s). The battery also receives electrical power from the electric machine(s) when it is operating as a generator. The battery may be a battery pack made up of several battery modules, where each battery module contains a plurality of battery cells. Other vehicles may use different types of energy storage devices, such as capacitors and fuel cells that supplement or replace the battery. The vehicle 16 includes a power electronics including a variable voltage converter (VVC), an inverter, etc. connected between the traction battery and the electric machine(s).

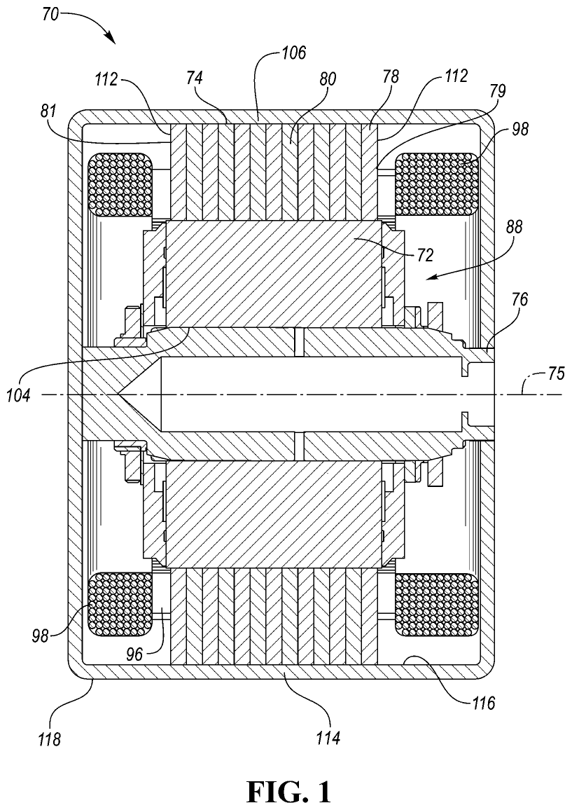

Referring to FIG. 1, an example electric machine 70 includes a stator 74 that may have a plurality of laminations 78. The electric machine 70 has a central axis or centerline 75. Each of the laminations 78 includes a front side and a back side. When stacked, the front and back sides are disposed against adjacent front and back sides to form a stator core 80. Each of the laminations 78 define a hollow center.

Each lamination 78 includes an inner diameter defining a plurality of teeth. Adjacent teeth cooperate to define slots. The teeth and the slots of each lamination 78 are aligned with adjacent laminations to define stator slots extending axially through the stator core 80 between the opposing end faces 112. The end faces 112 define the opposing ends of the core 80 and are formed by the first and last laminations 79, 81 of the stator core 80. A plurality of windings (also known as coils, wires, or conductors) 96 are wrapped around the stator core 80 and are disposed within the stator slots. The windings 96 may be disposed in an insulating material (not shown). Portions of the windings 96 generally extend in an axial direction along the stator slots. At the end faces 112 of the stator core, the windings 96 bend to extend circumferentially around the end faces 112 of the stator core 80 forming the end windings 98. While shown as having distributed windings, the windings could also be of the concentrated or hairpin type.

A rotor 72 is disposed within the cavity 88 of the stator 74. The rotor 72 is fixed to a shaft 76 that is operably connected to the gearbox. When current is supplied to the stator 74, a magnetic field is created causing the rotor 72 to spin within the stator 74 generating a torque that is supplied to the gear box via one or more shafts or gears, or the like. The electric machine may also act as generator by mechanically rotating the rotor 72 to generate electricity. Details of the rotor 72 will be described below.

Rotors may generate heat during operation and require cooling. In induction rotors, electromagnetic losses in their rotor cage result in heating of the rotor. The rotor may be liquid cooled to maintain desired temperatures. Maintaining desired rotor temperatures may increase part life, reduce cage conduction losses (the cage materials, e.g., aluminum or copper, have temperature dependent resistivity), reduce degradation of the working fluid, and mitigate heat transfer to the stator.

Many existing induction machines use air cooled or fluid cooling only on the end ring portion of the cages. This may be suitable for lower power applications, but this type of cooling may be insufficient to support higher power-density induction machines.

The electric motor 70 may be a higher power-density induction machine cooled by circulating a fluid through the rotor and/or the stator in order to target the heat generating areas more directly than spray or air cooling. This may be in addition to any spray cooling (optional). The fluid may be any dielectric fluid such as oil, e.g., automatic transmission fluid (AFT). This fluid is sometimes called “eFluid.” The fluid may travel through a fluid path of the electric machine and is connected in fluid communication with a thermal management system (not shown).

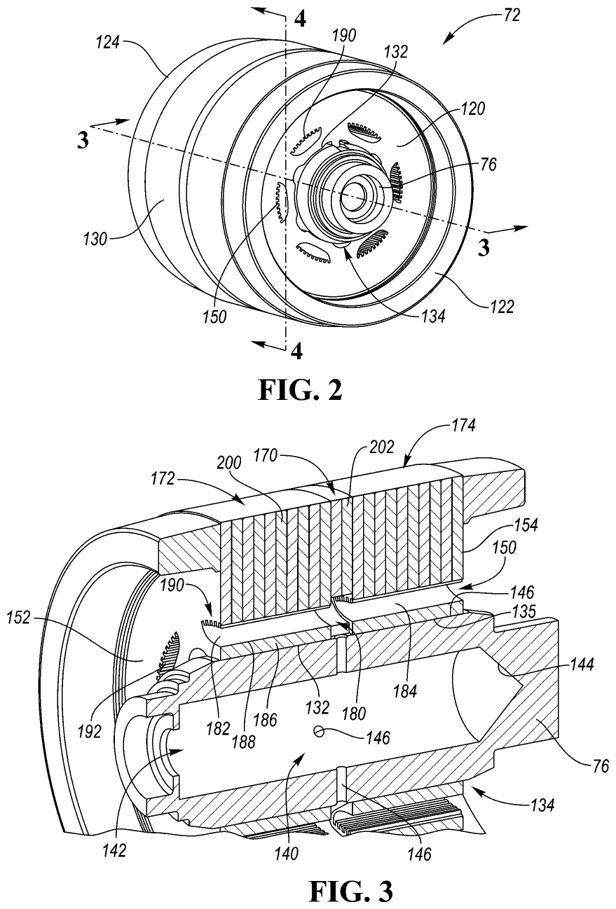

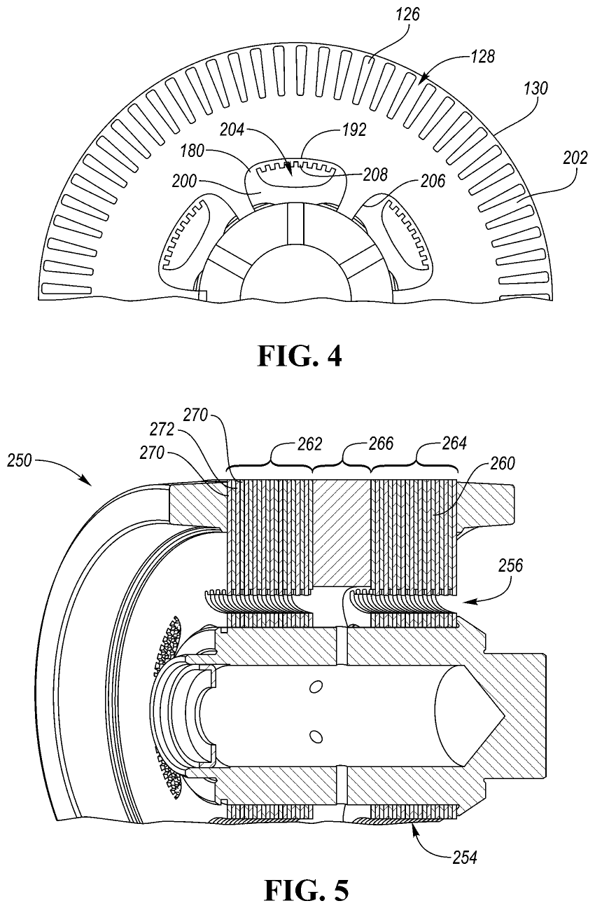

Referring to FIGS. 2, 3, and 4, the rotor 72 may be induction rotor (as shown) or other type. The rotor 72 includes a rotor core 120 and a squirrel cage having end rings 122, 124 and conductor bars 126 connecting between the end rings. The conductor bars 126 extend through slots 128 located near (or alternatively, recessed into) the outer diameter (also known as an outer circumferential surface) 130 of the rotor core 120. The inner diameter 132 defines a central hole 134 extending axially (longitudinally) and completely through the rotor core 120. The shaft 76 extends through the hole 134 with the outer circumferential surface 135 of the shaft 76 disposed against the inner diameter 132 of the rotor 72. The shaft 76 and the rotor 72 are rotatably coupled such that they rotate in unison. The shaft 76, the rotor 72, or both may include an anti-rotation features such as the shown keyway.

The rotor 72 may be actively cooled by circulating fluid therethrough. The fluid that circulates to the rotor may be part of a larger fluid circuit that cools the entire electric machine 70. The shaft 76 may be hollow to provide fluid to the rotor 72. For example, the shaft 76 includes a fluid passageway 140 that extends from an oil inlet 142 to a closed end 144 of the shaft 76. The shaft includes one or more orifices 146 that extend radially from the central passageway 140 to the outer circumferential surface 135 of the shaft. In the illustrated embodiment, the shaft 76 includes six orifices, which corresponds to the number of fluid channels in the rotor (discussed infra). In the illustrated embodiment, the orifices 146 are located at an axial center of the rotor core 120 but may be axial shifted along the centerline 75 in other embodiments.

The rotor core 120 includes one or more cooling channels 150 that are in fluid communication with one or more of the orifices 146. Each of the cooling channels 150 may extend axially completely through the rotor core 120. That is, the cooling channel 150 extends from a first end face 152 to the other and face 154. During operation, fluid is supplied to the shaft 76 via the oil inlet 142 and builds within the hollow center 140 of the shaft 76. The oil is forced radially outward through the orifices 146 and subsequently into the midpoint of the axial cooling channels 150. From there, the oil splits with some of the oil flowing towards the end face 152 and the rest flowing towards the end face 154. The oil, which is cooler than the rotor 72, removes heat from the rotor as it flows therethrough. The electric machine 70 may be designed such that the fluid exiting the axial fluid channels 150 is sprayed or drips onto other components of the electric machine such as the end rings 122, 124. This exiting fluid may also aid in cooling of the stator.

The rotor core 120 may generally have three portions: a central portion 170, a first end portion 172, and a second end portion 174. The central portion 170 is sandwiched between the end portions 172, 174 and in the illustrated embodiment is axially thinner than the end portions.

The illustrated embodiment, the purpose of the central portion 170 is to provide access into the channels 150 and to form plenums 180 that feed fluid to the channel portions 182, 184 of the cooling channels 150. The plenums 180 are optional. The plenum 180 is enlarged compared to the channel portions 182, 184 in both the radial and the circumferential directions. The larger plenums 180 allow for pooling of fluid to ensure sufficient flow rates through the channels 150. In the illustrated embodiment, the plenums 180 are recessed into the inner diameter 132 of the rotor core 120. As such, the shaft orifices 146 directly open into the plenums 180 to supply fluid to the channels 150.

In other embodiments, the plenums may be shifted outwardly and additional openings or orifices may be used to supply fluid from the shaft orifices to the plenums. In other embodiments, the plenums may not be formed directly at the center of the rotor core and instead could be axially shifted towards one end or the other. Here, the shaft orifices would also be shifted so that they remain in fluid communication. In some embodiments, the location of the plenums may be different than each other. That is, some plenums may be shifted towards the end face, others may be located in the center, while others may be shifted towards the other end face. Here again, the shaft orifices would be placed to align with their corresponding plenum. An undercut may be formed on the sides of the plenum, which acts as an impeller or centrifugal pump at lower speeds increasing the fluid pressure so that it fills the plenum radius before entering the axial cooling channels.

Unlike the plenum 180, the channel portions 182, 184 of the channels 150 may be positioned radially outboard of the inner diameter 132 of the rotor core. As best seen in FIG. 3, a strip of material 186 separates the inboard surface 188 of the channel portions 182, 184 from the inner diameter 132. The channel portions 182, 184 also have an outboard surface 190. The Plenum 180 does not include inboard surface but does include an outboard surface 192 that is radially spaced from the centerline 75 by a distance that is greater than the distance between the outboard surfaces 190 and the centerline 75.

The channels 150 may include fins 192 or other features for increasing heat transfer between the rotor 76 and the fluid. The fins 192 may extend axially through a portion or the entirety of the channel 150. In the illustrated embodiment, the fins 192 are located within the channel portions 182, 184 but not within the plenum 180. The fins may be located on the outboard surfaces 190 of the channels 150, the inboard surfaces, or both. In the illustrated example, the fins are only disposed on the outboard surfaces 190. The fins 192 may extend in parallel rows (see, e.g., FIG. 2) or may be staggered as described below (see e.g., FIG. 5).

The rotor core 120 may be a stack of laminations. The stacked laminations may include two or more types of laminations. In the illustrated embodiment of FIG. 3, the rotor 72 includes two types of laminations. A first type lamination 200 is used in the end portions 172, 174, and a second type of lamination 202 is used in the central portion 170. The laminations are fabricated such that they form the various features of the cooling path when stacked. For example, the laminations 200 include openings 204 that cooperate with the openings of adjacent laminations to form the channel portions 182, 184 of the channels. The openings 204 also include tabs or projections 208 that form the fins 192. Similarly, the laminations 202 of the central portion 170 include openings 206 that cooperate with each other to form the plenums.

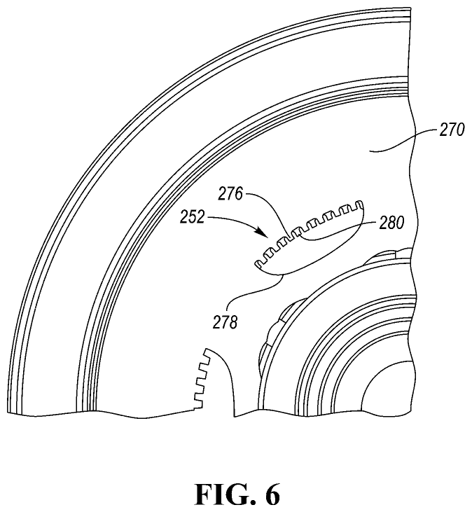

Referring to FIGS. 5 and 6, another rotor 250 is similar to the rotor 72 but has a staggered fin arrangement 252. The staggered fin arrangement 252 may increase cooling efficiency. The staggered arrangement may be provided along the length of the channel portions 254 of the cooling channels 256. The staggered arrangement 252 may be created by having a first number of fins or tabs at first axial locations of the cooling channel 256 and a second number of fins or tabs (that is different than the first number of fins) at second axial locations, wherein these first and second number of fins may alternate along the length of the cooling channel 256. For example, they may alternate every other along the length of the stack. As shown in the illustrated embodiment, the first number of fins includes seven fins, whereas the second number of fins includes six fins. Here, the seven fins of the first locations are positioned to fall in between adjacent ones of the six fins of the second locations.

As described above, the rotor core 260 of the rotor 250 may or may not be formed by a plurality of laminations. In the illustrated example, the rotor core 260 is formed of a plurality of laminations. The staggered arrangement may be formed by using multiple different types of laminations. In this example, three types of laminations may be used with two types forming the end portions 262, 264 and another type forming the central portion 266. (Optional limitations of central portion 266 not shown in FIG. 5.) In some embodiments, the central portion 266 may be formed of a single solid piece, whereas the end portions 262, 264 are formed of laminations.

The example end portion 262 may include a first type lamination 270 and a second type of lamination 272. The first and second types of laminations 270 and 272 may differ only in the placement of the tabs or fins. For example, the first type of laminations 270 includes seven fins 276 within each of the openings 278, and the second type of laminations 272 includes six fins 280. As described above, the fins may be located at the outboard surface of the openings (as shown), at the inboard surface of the openings, or both. In an alternative embodiment, the first type of laminations may have their fins at the outboard surface of the openings whereas the other type of laminations may have their fins at the inboard surfaces of the openings.

In the illustrated example, the first and second types of laminations 270, 272 alternate one after the other along the length of the end portions 262, 264. The fins 276 and 280 are circumferentially staggered, that is, axially adjacent ones of the fins 280 are not aligned with each other. The fins 276, 280 of adjacent ones of the laminations are circumferentially offset, i.e., rotated, relative to each other to create the staggered arrangement 252. In the illustrated embodiment, the fins of adjacent laminations are offset such that the fins 276 are aligned with a midpoint of the gaps between the fins 280 and vice versa.

In another example (not shown), a partial staggered arrangement of fins may be used. In this embodiment, each fin is axially aligned with one adjacent fin and is circumferentially offset relative to another adjacent fin. This creates a partial staggered arrangement in which the circumferential position of the fins changes every two laminations (this may be called a 2-2pattern). In other embodiments, three (3-3 pattern), four (4-4 pattern), or more laminations may be grouped to have the same fin pattern. Also, the groupings need not have a uniform number of laminations. For example, the stator may include a 1-2 pattern in which a first lamination in sequence has a first fin pattern, the second and third laminations have a second fin pattern, and the fourth fin repeats the sequence and has a fin pattern that matches the first lamination. Of course, 2-3 patterns, etcetera, are also contemplated.

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure. however, could be desired for particular applications or implementations.

What is claimed is:

1. An electric machine comprising:
a shaft defining an axial fluid passage and a radial orifice extending from the fluid passage to an outer circumferential surface of the shaft;
a rotor supported on the shaft, the rotor including:
a stack of laminations defining a rotor core,
an axial fluid channel defined in the rotor core and in fluid communication with the orifice and fluid passage, and
a plurality of fins each extending from the rotor core into the fluid passage such that the fins axially extend along at least a portion of the axial fluid channel.

2. The electric machine of claim 1, wherein the axial fluid channel includes an outboard surface and an inboard surface, wherein the fins are disposed on the outboard surface and the inboard surface is without fins.

3. The electric machine of claim 1, wherein the fins are integrally formed with the laminations.

4. The electric machine of claim 3 wherein the laminations include a first set of laminations having the fins and a second set of laminations without fins so that the fins extend along a portion of the axial fluid channel.

5. The electric machine of claim 4, wherein the first set of laminations includes an outboard surface radially spaced from the outer surface of the shaft via a first distance, and the second set of laminations includes an outboard surface radially spaced from the outer surface by a second distance that is greater than the first to create a fluid plenum.

6. The electric machine of claim 5, wherein an outlet end of the orifice opens into the plenum.

7. The electric machine of claim 6, wherein the first set of laminations is a pair of lamination sets that sandwich the second set of laminations.

8. The electric machine of claim 1, wherein the axial fluid channel is a plurality of axial fluid channels circumferentially arranged around the rotor.

9. The electric machine of claim 1, wherein the rotor core includes an inner circumferential surface disposed on the shaft and an outer circumferential surface, wherein the axial fluid channel is radially disposed between the inner and outer surfaces of the rotor core.

10. The electric machine of claim 9, wherein the inner surface defines an opening connecting the axial fluid channel in fluid communication with the orifice.

11. The electric machine of claim 1 further comprising a stator circumscribing the rotor.

12. The electric machine of claim 1, wherein the rotor core defines a plurality of slots, and wherein the rotor further includes a pair of end rings and conductor bars connected between the end rings and disposed in the slots to form a squirrel cage.

13. A rotor of an electric machine comprising:
a rotor core including a central set of laminations disposed between first and second outer sets of laminations, wherein each of the first and second outer sets of laminations defines an axial fluid channel that has an outboard surface and an inboard surface, and the central set of laminations defines a fluid plenum having an outboard surface that is radially spaced from a central axis of the rotor core by a distance that is greater than a distance between the central axis and the outboard surfaces of the axial fluid channels of the first and second outer sets of laminations.

14. The rotor of claim 13, wherein the laminations of the first and second outer sets define tabs projecting into their corresponding axial fluid channel.

15. The rotor of claim 14, wherein the fluid plenum does not have tabs.

16. The rotor of claim 14, wherein at least some of the tabs are circumferentially staggered relative to other ones of the tabs.

17. The rotor of claim 13, wherein the first outer set of laminations includes a first type of lamination having first tabs projecting into the axial fluid channel and a second type of lamination having second tabs projecting into the axial fluid channel, wherein the first and second tabs are located at different circumferential positions of the rotor core and the first and second types of laminations alternate along the length of the first set such that the tabs form staggered fins disposed in the axial fluid channel.

18. An electric machine comprising:
a rotor core including:
a central portion having an outer circumferential surface and an inner circumferential surface, the inner surface defining a fluid plenum recessed therein and extending completely through an axial thickness of the central portion, wherein the fluid plenum has an outboard surface spaced from a central axis of the rotor core by a first distance,
a first end portion axially thicker than the central portion and disposed against a first end face of the central portion, the first end portion having an outer circumferential surface, an inner circumferential surface, and a first axial fluid channel disposed therebetween, the first axial fluid channel having an outboard surface spaced from the central axis of the rotor core by a second distance that is less than the first distance, and
a second end portion axially thicker than the central portion and disposed against a second end face of the central portion such that the central portion is disposed between the first and second end portions, the second end portion having an outer circumferential surface, an inner circumferential surface, and a second axial fluid channel disposed therebetween, the second axial fluid channel having an outboard surface spaced from the central axis of the rotor core by a third distance that is less than the first distance,
wherein, the plenum is circumferentially aligned with the first and second fluid channels forming a continuous opening extending axially through the rotor core.

19. The electric machine of claim 18, wherein the inner circumferential surfaces of the portions define a central hole with a discontinuous sidewall at the plenum, and further comprising a shaft coaxial with the central axis and received through the central hole to couple with the rotor core, the shaft defining an axial fluid passage and a radial orifice extending from the fluid passage to the plenum.

20. The electric machine of claim 18, wherein the first axial fluid channel further has an inboard surface that is radially spaced from the inner circumferential surface of the first end portion.
